(19) United States
(12) Patent Application Publication
(10) Pub. No.: US 2025/0264247 A1
(43) Pub. Date: Aug. 21, 2025

(54) ELECTRIC HEATING DEVICE FOR A MOTOR VEHICLE

(71) Applicant: VALEO SYSTEMES THERMIQUES, Le Mesnil-Saint-Denis (FR)

(72) Inventors: Frédéric Moulinas, Le Mesnil-Saint-Denis (FR); Erwan Gogmos, Le Mesnil Saint-Denis (FR); Thomas Bernhardt, Bad Rodach (DE)

(73) Assignee: VALEO SYSTEMES THERMIQUES, Le Mesnil-Saint-Denis (FR)

(21) Appl. No.: 18/992,979

(22) PCT Filed: Jul. 10, 2023
(86) PCT No.: PCT/EP2023/069020

§ 371 Date: Jan. 10, 2025

(30) Foreign Application Priority Data
Jul. 11, 2022 (FR) 2207073

(51) Int. Cl. F24H 3/04; B60H 1/22; F24H 9/1863; F24H 15/25

(52) U.S. Cl. CPC F24H 3/0441; B60H 1/2225; F24H 3/0435; F24H 9/1872; F24H 15/25; F24H 2250/04

(57) ABSTRACT

An electric heating device, for a motor vehicle, the electric heating device including an electrical connection box and a heating body. The heating body includes a plurality of heating elements intended to be supplied with current; a plurality of metal tubes, at least some of which include the heating elements; and a plurality of metal heat sinks. The metal tubes and the metal heat sinks form a conductive casing with the same electrical potential. At least one tube of the plurality of tubes includes a conductive element projecting from the at least one tube and in contact with the at least one tube. The projecting element is connected to a ground connector of the electrical connection box.

The present invention relates to the field of the heating of motor vehicles, and it relates more particularly to an electric heating device, notably for a motor vehicle.

In vehicles with a combustion engine, the heating of the interior is currently effected by reusing the heat energy produced by the combustion engine of such a vehicle. In vehicles with an electric motor, in which this heat energy is not available, it is known to use electric heating devices to heat the vehicle interior. This electric heating is currently effected by a radiator comprising heating elements, for example heating resistors.

Such a radiator comprising a heating body made of aluminum is known from the prior art. This heating body comprises a plurality of tubes in which the heating elements are mounted, and a plurality of heat sinks in the form of fins which separate each of the tubes of this plurality of tubes. This heating body is topped by an electrical connection box which has to be mounted in a fluid-tight manner on an upper portion of the heating body, from which upper portion the connections of the heating elements intended to be electrically connected to the electrical connection box exit. Specifically, the air brought through the heating body of the electric radiator before being directed to the interior may be humid, and this humidity must not adversely affect the electrical connections of the radiator. A seal is therefore placed on the upper periphery of the heating body and separates the upper portion of the heating body, said upper portion comprising the electrical outputs of the heating elements of the heating body, and the electrical connection box.

The makeup of the electric heating device involves providing a ground return for the metal frame formed by the tubes and the fins, and this ground return must be as small and simple as possible, it being understood that the ground connector to which the metal frame must be connected is secured to the electrical connection box. Wired electrical connections extending from an outer face of the heating body by bypassing the box are disadvantageous for the mounting of the electric radiator in the associated heating installation and run the risk of becoming damaged during the mounting. It is thus known to provide an additional component, pressed against the heating body and longitudinally extending this heating body so as to be able to be housed in the electrical connection box and then be connected to the ground connector with an electrical conductor extending mainly in the connection box. The presence of this additional component involves increasing the size of the opening made in the electrical connection box in order to enable the connection of the heating body, and this has the result that the seal mentioned above must be resized.

The present invention proposes an electric heating device which remedies the drawbacks of the prior art mentioned above, that is to say the connection thereof to ground is reliable, safeguarded, and established without any implications for the design of the other components of the heating device and notably for the size and the position of the sealing means at the junction between the heating body and the electrical connection box.

To this end, the invention proposes an electric heating device, notably for a motor vehicle, said device comprising an electrical connection box and a heating body comprising a plurality of heating elements intended to be supplied with current, a plurality of metal tubes, at least some of which comprise said heating elements, and a plurality of metal heat sinks, the metal tubes and the metal heat sinks forming a conductive frame at the same electrical potential, said device being characterized in that at least one tube of said plurality of tubes comprises a conductive element which protrudes from said at least one tube and is in contact with said at least one tube, said protruding element being connected to a ground connector of said electrical connection box.

More particularly, the conductive element protruding from said at least one tube is in electrical contact with said at least one tube. Here, electrical contact is understood to mean the ability of the conductive element to transmit a current from the conductive frame to the ground connector, it being understood that, during normal operation of the heating device, the electrical current is not supposed to circulate within the conductive frame.

By virtue of the invention, since the connection to ground of the heating body utilizes a conductive element housed within one of the tubes of the heating body, this conductive element does not hinder the mounting of the heating body in the connection box. Specifically, by forming part of one of the tubes of the heating body, said conductive element does not change the volume allocated for the heating body. On the contrary, during the mounting of the heating body on the electrical connection box, with the simultaneous connection of each of the heating elements on the electrical box, the conductive element protruding from the tube at one end thereof is located directly in a connection zone between the connection box and the heating body and can thus be housed inside a seal comprised between an upper periphery of the heating body and the electrical connection box.

According to one feature of the invention, the heating device is a high-voltage device, in other words a device whose electrical voltage is greater than 48 V or 52 V, for example equal to 400 V or 800 V. According to one feature of the invention, the heating elements comprise at least one resistive element, in particular positive temperature coefficient (PTC) resistive element, clamped between two electrodes.

According to one feature of the invention, the conductive element is a separate element from these electrodes. In other words, the conductive element is electrically insulated from these electrodes. In other words, the protruding conductive element does not transmit current to said at least one resistive element.

According to one feature of the invention, the conductive element protruding from said at least one tube is a metal bar disposed longitudinally in said at least one tube, said metal bar comprising at least one metal tab in contact with an inner surface of said at least one tube. Such an embodiment of the invention makes it possible to manufacture the metal tubes by extrusion without it subsequently being necessary to recut the tubes, since the metal bar is a separate element from said at least one tube. The position of the metal bar within the tube is ensured by a suitable elasticity of the metal tab, the spacing of which with respect to a main plane of elongation of the bar is such that contact is ensured with the inner surface of the tube during the insertion. Furthermore, the metal tab has an elasticity compatible with the adjustment of the size of said at least one tube, the latter being intended to be deformed in the same way as the tubes which comprise within them heating elements are for fixing the position of the heating elements in the tubes.

According to one feature of the invention, said at least one metal tab is a lateral portion of said metal bar, articulated on a body of said metal bar at a base of said metal tab. The metal tab advantageously has a hook shape with a rounded portion intended to be in contact with the inner surface of the tube, and a free end which points toward the body of the metal bar. The articulation of the metal tab enables, by way of the elasticity of the metal tab, easy insertion of the metal bar into said at least one tube, with the hooks deforming by flattening during this insertion, and ensuring good contact between the tabs and said at least one tube. The tab is for example obtained by cutting and then bending of a lateral portion of the metal bar. This embodiment of the tabs is simple and inexpensive to manufacture.

According to one feature of the invention, said at least one tube further comprises an electrical connection member protruding from said at least one tube, the protruding part of said electrical connection member being electrically connected to an electrical power supply in said electrical connection box. This optimizes the space present in said at least one tube. This electrical connection member is for example a positive or negative busbar.

According to one feature of the invention, said electrical connection member and said metal bar are at least partially embedded in an insulating polymer material, on a longitudinal portion of said electrical connection member and of said metal bar. Said longitudinal portion covers neither said at least one metal tab nor the ends of said electrical connection member and of said metal bar which are intended to be electrically connected to said electrical connection box. This overmolding ensures the electrical insulation between the metal bar and the electrical connection member. In addition, it facilitates the insertion and the positioning of the metal bar and of the electrical connection member in the tube by grouping them together as an overmolded block.

According to one feature of the invention, said metal bar comprises several metal tabs distributed uniformly along said metal bar. This makes it possible to ensure good contact between the metal bar and the inner surface of the tube, and to ensure that the metal bar is substantially parallel to the inner surface of the tube.

According to one feature of the invention, said at least one tube further comprises another metal bar comprising one or more metal tabs in contact with said inner surface of said at least one tube, said metal bar and said other metal bar being disposed on either side of a median plan longitudinally intersecting the width of said at least one tube, said metal bar and said other metal bar being secured to one another. This other metal bar secured to said metal bar makes it possible to correctly position the latter in the tube, and enables better conductive contact between the tube and said metal bar when the securing means between these bars is itself conductive. When the securing is effected by overmolding, for example said other metal bar and said metal bar being positioned in this overmolding on either side of an electrical connection member, said other metal bar then notably has a function of assisting the positioning of the overmolded block in the tube.

According to one feature of the invention, the metal tabs of said metal bar, or of said metal bar and of said other metal bar, protrude from the same side of said metal bar or of said metal bars. This arrangement of the metal tabs makes it possible to arrange heating elements or sensors, for example, on one side of the metal bar or of the metal bars, that is to say on the opposite side from the metal tabs.

According to one feature of the invention, said at least one tube further comprises one or more temperature sensors disposed on the opposite side from said same side of said metal bar or bars, said temperature sensors being in contact with a wall of said at least one tube. This arrangement optimizes the use of the tube when it does not comprise heating elements, the tube being used for the sensors and any connecting wires for the sensors that enable electrical connection to said electrical connection box. Preferably, the wall against which the sensors rest is in contact with one heat sink of said plurality of heat sinks. Thus, the reliability of the sensors is improved.

According to one feature of the invention, said at least one tube is disposed at a lateral edge of said heating body. Thus, it does not disrupt the heat dissipation from the rest of the heating body, the arrangement of which is optimized for this heat dissipation.

According to one feature of the invention, and as an alternative to the main variant embodiment of the invention, said protruding conductive element is a metal finger extending a wall of said at least one tube. It will be understood that, in this variant, the protruding conductive element is no longer realized by an added component like the metal bar, but directly by the tube and a specific shape thereof. has the drawback of needing to cut said at least one tube after extrusion and is therefore not preferred.

Other features and advantages of the invention will also become apparent both from the description below and from several exemplary embodiments given by way of nonlimiting indication with reference to the attached schematic drawings, in which:

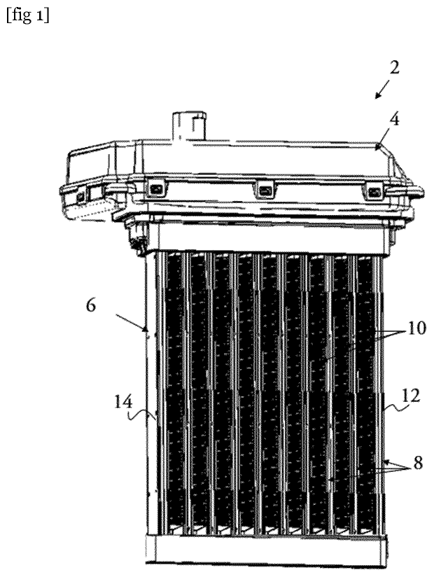

FIG. 1 illustrates an electric heating device according to the invention, notably rendering visible a heating body, comprising a plurality of tubes and heat sinks, and an electrical connection box connected to an upper portion of the heating body,

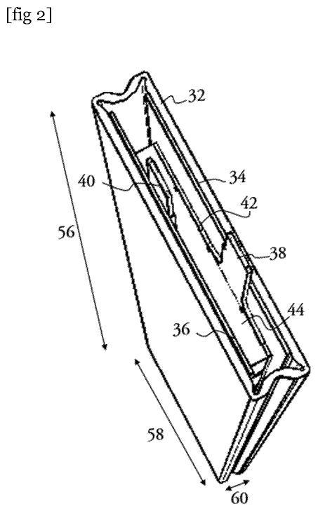

FIG. 2 is a perspective depiction of one of the tubes of the device in FIG. 1, heating elements being arranged in said tube,

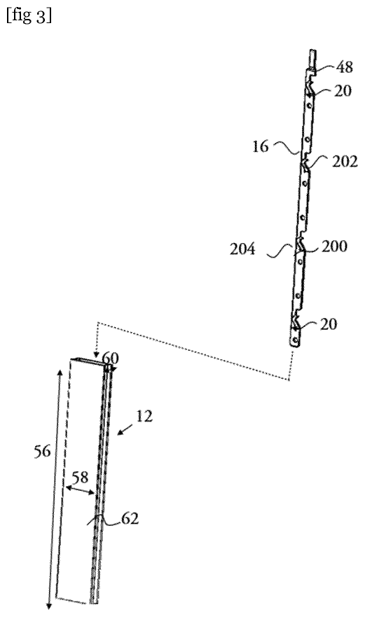

FIG. 3 shows an exploded view of a conductive element intended to be connected to ground and of one of the tubes of the device in FIG. 1, said tube being separate from the tube in FIG. 2 and having this conductive element inserted therein,

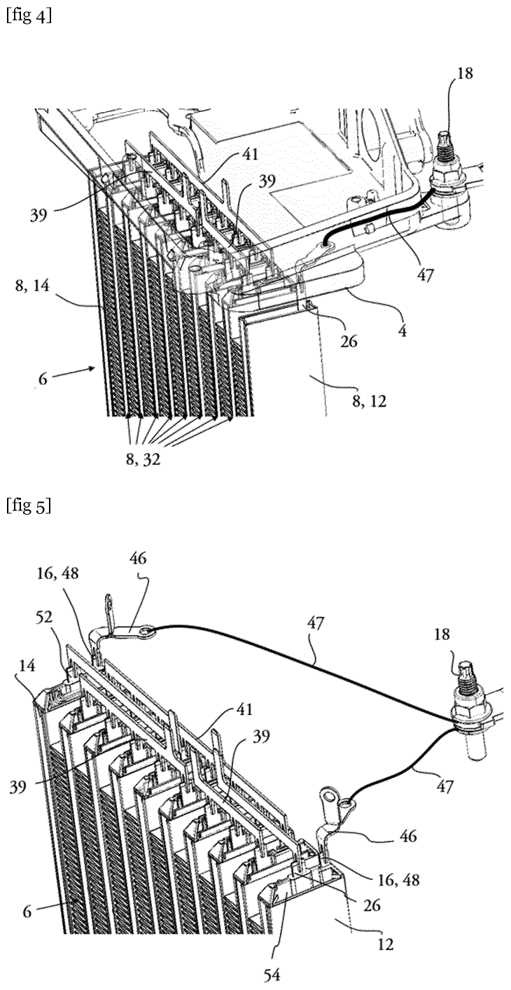

FIG. 4 is a perspective depiction of an upper portion of the heating body of the heating device in FIG. 1, and the electrical connection box shown partially and in transparency, so as to more particularly render visible the connection to ground of a conductive element protruding from the tube in FIG. 3,

FIG. 5 is a perspective depiction of a view similar to that in FIG. 4, this time without the electrical connection box, so as to illustrate an embodiment variant which differs from the preceding figures by the content of the tube housing the conductive element connected to ground,

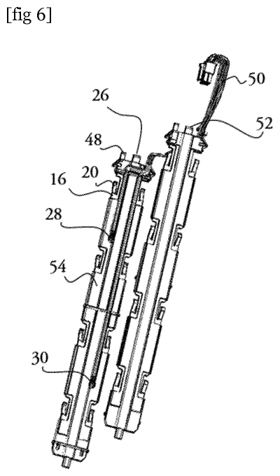

FIG. 6 shows a detail perspective view of two conductive elements intended to be connected to ground and to be housed respectively in one of the tubes of the heating body in FIG. 5, with metal bars and an electrical connection member which are embedded in an insulating polymer material,

FIG. 7 shows the elements in FIG. 6 housed in a corresponding tube, the tube being shown in transparency,

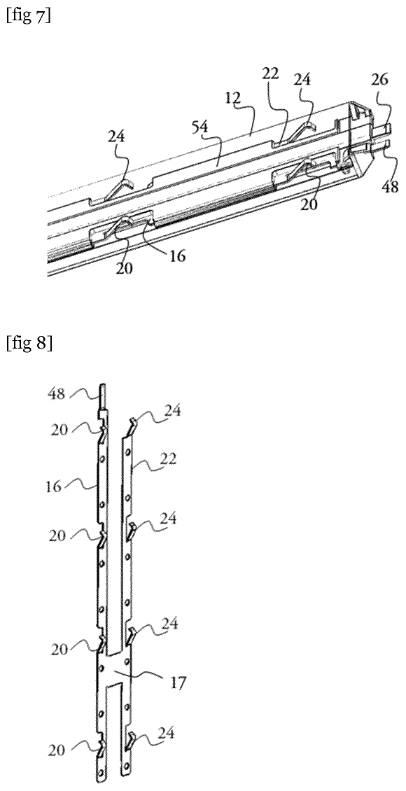

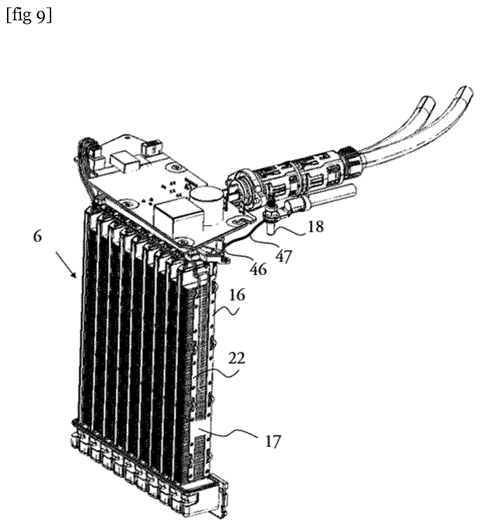

FIG. 8 shows a variant of a conductive element intended to be connected to ground and to be housed in one of the tubes of the heating body visible in FIG. 3, with two metal bars secured to one another, and

FIG. 9 shows the conductive elements in FIG. 8 disposed in the electric radiator, without the tube that comprises these elements so as to render them visible.

It will be recalled that the invention relates to an electric heating device for a motor vehicle with specific grounding means, and notably one or more conductive elements which protrude respectively from a tube and are in contact with the corresponding tube, these conductive elements being connected to a ground connector.

An embodiment in which the conductive element consists of a single metal bar housed in the corresponding tube will first be described, notably with reference to FIGS. 1 to 4.

The electric heating device 2 according to the invention is intended to heat the interior of a motor vehicle, notably an electric vehicle, and comprises an electrical connection box 4 connected to an electrical power supply network of the vehicle, to at least one computer of the vehicle and to a ground connection of the vehicle. This connection box 4 therefore comprises a positive power supply bus, a negative power supply bus, a ground connector 18, as visible in FIG. 6 by way of example, and a connection to a computer bus.

The electric heating device 2 also comprises a heating body 6 intended to be passed through by a flow of air to be heated and comprising a plurality of resistive elements which generate heat transmitted to the flow of air as a function of a suitable electrical power supply from the connection box 4. To this end, the heating body 6, in an upper portion of the heating body, is fastened in a fluid-tight manner to the connection box, notably with a seal (not visible here) which extends over the periphery of the heating body.

The heating body 6 is made up of an alternation of metal tubes 8 and heat sinks 10, which are also metal. By way of nonlimiting example, the metal tubes and the heat sinks are made of aluminum.

The metal tubes 8 are distinguished into two types depending on what they house within them, with heating tubes 32, which can notably be disposed at the center of the heating body, and electrical connection tubes 12, 14, which can notably be disposed at the lateral ends of the heating body, at the end of the stack of tubes and heat sinks. It should be noted that, in the illustrated example, the shape of the heating tubes and of the electrical connection tubes is the same, and it is possible to distinguish them only by what is housed within them.

The heating tubes 32 comprise heating elements whose heat is transmitted by the walls of the heating tubes to the heat sinks 10 in the form of fins, which diffuse the heat into the vehicle interior.

In FIG. 1, the heating body 6 thus has a parallelepipedal overall shape, the lateral walls of the heating body 6 being formed by two lateral tubes, in this case forming the electrical connection tubes 12, 14. The length of the heating body 6 is equal to the length of one of the tubes 8, the width of the heating body being equal to the distance separating the lateral tubes, and the height of the heating body being the width of one of the lateral walls, that is to say the width of one of the tubes 8.

A heating tube 32, comprising heating elements, is shown in FIG. 2. Like each of the tubes 8, the heating tube 32 has a parallelepipedal shape overall, and the heating tubes are arranged in the heating body such that the length 56 of the heating tube 32 corresponds to the length of the heating body 6 and such that the width 58 of the tube 32 corresponds to the height of the heating body 6. The smallest dimension of this parallelepiped furthermore corresponds to the thickness 60 of the heating tube 32.

The heating elements are in the form of positive temperature coefficient (PTC) resistive elements 44, specifically in the present case ceramic stones with PTC effect. These resistive elements 44 are passed through by a current transmitted by two electrodes 38 and 40 when the electric heating device 2 is in operation. The electrodes 38 and 40 are electrically insulated from the tube 32 by two insulating layers 34 and 36. Several resistive elements 44 are mounted in parallel between the two electrodes 38 and 40 along the tube 32. The resistive elements 44 comprise, on each of their surfaces in contact with an electrode 38, 40, a metal layer 42, for example made of aluminum. It should be noted that this embodiment of the heating elements implies no limit on the invention, as long as they are housed in a heating tube 32 similarly to what has been described above.

As is visible in FIG. 4, for each heating tube 32, a first electrode 38 is secured to a positive power supply bus 39 electrically connected to the electrical connection box 4 of the electric heating device 2 when the heating body is fastened to the electrical connection box 4. Analogously, for each heating tube 32, the second electrode 40 is secured to a negative power supply bus 41 electrically connected to the electrical connection box 4. It is thus possible to simultaneously supply several heating elements via a command of the electrical connection box 4. Several positive power supply buses 39 may be provided in order to enable differentiated control for several groups of heating elements.

As mentioned above, the conductive element consists of a single metal bar housed in the corresponding tube. In this embodiment, at least one electrical connection tube 12, 14 comprises a metal bar 16 made of aluminum which is housed in the tube and a free end of which protrudes from the corresponding electrical connection tube in the direction of the length of this tube, toward the connection box 4, as is notably visible in FIG. 4. In this case, each of the tubes disposed at the lateral ends of the heating body comprises such a metal bar, but in a variant it is possible to provide for a single tube of the heating body to comprise a metal bar 16, this tube not necessarily being disposed at a lateral end of the heating body 6.

In accordance with what has been mentioned above, the connection tube 12, 14 has a shape and dimensions equivalent to those of the heating tube 32, such that it is possible to identify the length 56 of the connection tube, in a longitudinal direction, the width 58 and the thickness 60 of the connecting tube in FIG. 3.

It being understood that the internal arrangements of the electrical connection tubes 12, 14 may be similar, only one of the electrical connection tubes 12 is detailed here, notably with reference to FIG. 3. That part of the metal bar 16 which goes beyond the tube 12 in the direction of the connection box 4, once the metal bar has been inserted in the tube, that is to say the free end visible in FIG. 4, is a metal finger 48 on which a connector 46 is welded. This connector is itself connected by an electrical conductor 47, shown schematically in this case in FIG. 4, to the ground connector 18 of the connection box 4.

Since the metal finger 48 goes beyond the walls of the connection tube 12 and thus forms a longitudinal protrusion with respect to this connection tube, it is possible to ground the heating body 6 via this metal finger which extends in the longitudinal continuation, toward the connection box 4, of the envelope defining the heating body. A seal used for sealing the junction between the upper periphery of the heating body 6 and the connection box 4 thus ensures that this connection to ground is also fluid-tight, without it being necessary to provide a greater dimensioning of the seal. Advantageously, no electrical conductor that enables the connection to ground extends outside the heating body, and this makes it possible to not hinder the mounting and to avoid the risk of this mounting damaging the electrical conductor.

The metal bar 16 incorporated in the connection tube 12 has a substantially flat body and metal tabs 20 distributed regularly along the metal bar 16, which have the purpose of ensuring contact between the metal bar and the connection tube 12. The metal tabs 20 are articulated on the body of the metal bar 16 at a base 200 of the tab, defining the axis of articulation, and it will be understood that this flexibility ensures contact with the connection tube without running the risk of not being able to insert the metal bar into the connection tube.

A metal tab 20 is produced by an operation of cutting a longitudinal edge of the metal bar 16 followed by different bending operations. The metal tab 20 is bent a first time to free the tab from the plane in which the body of the metal bar is inscribed and to thus form a protrusion, articulated about the base 200. The metal tab is then bent a second time, such that the free end 202 is brought back toward the body of the metal bar 16, so as to give the tab a hook shape with a rounded edge 204 which forms the contact surface between the tab 20 and the wall of the tube 12 facing this tab 20. This hook shape and this elasticity facilitate the insertion of the metal bar 16 in the tube 12 without the free end 202 rubbing against the inner surface of the tube.

The insertion of the conductive element, formed by the metal bar 16, into the connection tube 12, 14 is notably visible in FIG. 3, with the metal bar which is inserted into the connection tube through an opening formed at a longitudinal end of the connection tube. Since the metal bar 16 has a flat bar shape from which the tabs 20 protrude, the planar part of the metal bar 16 is inserted into the tube 12 facing a wall 62 of greater area of the tube 12, such that the hooks are able to come into contact with the inner surfaces of the connection tube which delimit the thickness 60 of this connection tube. The hooks are shaped so as to be slightly larger, in a direction in which the thickness 60 of the connection tube 12 is inscribed, than the opening in the tube through which the metal bar is inserted, and deform by flattening during the insertion, thus improving the chances of contact between the wall of the tube 12 and the tabs 20. In other words, the thickness 60 of the connection tube 12 is smaller than the mean distance between the rounded edge of the tabs and the plane in which the body of the metal bar 16 is inscribed.

As is visible in FIG. 3, the metal bar 16 is inserted in a direction such that the bases 200 of each of the tabs 20 enter the connection tube 12 before the rounded edge 204 of the corresponding tab, and this has the effect of once again facilitating the insertion of the metal bar. As a result, so that the metal finger 48 goes beyond the opening through which the metal bar 16 has been inserted, the metal finger is closer to the rounded edges 204 of the metal tabs 20 than the bases 200 thereof.

The contact between these tabs 20, forming part of the conductive element intended to be connected to ground, and an inner surface of the connection tube 12 makes it possible to ground the connection tube 12, and therefore to ground all of the tubes 8 and all of the heat sinks 10 of the heating body 6, given that these elements are made of metal and are in contact with one another.

An embodiment variant will now be described, with reference to FIGS. 5 to 8, which is distinguished from what has been described above in that the connection tube 12, 14 not only houses a conductive element which protrudes from the tube so as to be connected to ground but also an electrical connection member 26. This metal connection member 26 makes it possible to circulate the electrical current required for activating the heating elements within the heating tubes from the electrical connection box, on the side of the upper portion of the heating body, to a lower portion of the heating body where certain heating elements may have electrodes similar to those described for the upper portion of the heating body.

In the upper portion of the heating body, the electrodes 38, 40 associated with each of the heating tubes 32 are connected to power supply buses in order to be connected, as above, to the electrical connection box. The electrical connection members 26 present in the connection tubes 12, 14 are also connected to the electrical connection box via a power supply bus 43.

FIGS. 6 and 7 more particularly render visible the conductive element intended to be connected to ground and the electrical connection member 26 as they are when in the connection tube 12, 14.

In this embodiment variant, the connection tube 12 comprises, in addition to the metal bar 16, another metal bar 22 which also comprises metal tabs 24 regularly distributed longitudinally. These tabs 24 are similar to the tabs 20 and are disposed on the other metal bar 22 in the same way as the tabs on the metal bar 16.

The tabs 24 of the other metal bar 22 are also intended to come into contact with the inner surface of the corresponding connection tube 12, 14.

The metal bar 16 and the other metal bar 22 are secured to one another by being overmolded with a rigid synthetic material, for example a plastics material, so as to form a block that is easily positionable in the connection tube 12, 14. The overmolded block makes it possible to also arrange an electrical connection member 26, 52 in the connection tube 12, 14, without the risk of electrical contact between this electrical connection member 26, 52 and the metal bars 16, 22 being able to produce a short-circuit.

In FIG. 6, it is possible to see two overmolded blocks intended to be housed respectively in one of the connection tubes 12, 14 and each comprising a metal bar 16 and another metal bar 22 which are disposed on either side of an electrical connection member.

For the overmolded block intended to be housed in a first connection tube 12, the electrical connection member 26 is disposed between the metal bar 16 and the other metal bar 22 before overmolding of a longitudinal portion of this assembly formed by the electrical connection member and the metal bars. This overmolding 54, or overmolded longitudinal portion, does not cover the tabs 20, 24 and covers neither the longitudinal ends of the electrical connection member 26 nor the metal finger 48 forming an end of the metal bar 16.

By analogy, for the overmolded block intended to be housed in a second connection tube 14, the electrical connection member 52 is disposed between the two metal bars 16, 20 and the overmolding 54 of the assembly is effected so as to not cover the metal tabs and so as to not cover the ends that enable the electrical connections.

For each of the connection tubes, the overmolding 54 ensures the insulation between the electrical connection member 26, 54 and the metal bar 16, and between the electrical connection member 26, 54 and the other metal bar 22, set to the ground potential. The presence of the other metal bar 22, disposed on the other side from the electrical connection member 26, 54, makes it possible to provide the assembly with a stable position, substantially parallel to that wall of the tube against which the tabs 20, 24 rest, and this thus makes it possible to ensure that the electrical connection member 26 is disposed ideally, in accordance with a desired theoretical position, so as to be connected to the power supply buses both at the upper portion of the heating body and at the lower portion. In this context, the metal bar 16 and the other metal bar 22 are not connected, such that the metal tabs of the other metal bar only have the effect of correctly positioning the overmolded block within the connection tube. Only the tabs 20 of the metal bar 16 have the function of creating an electrical bridge between the wall of the tube, and therefore the heating body, and the ground connector 18, via successively the body of the metal bar, the metal finger 48 and the electrical conductor 47.

FIG. 7 illustrates the overmolded block comprising the overmolding 54, the metal bar 16, the electrical connection member 26 and the other metal bar 22, in transparency in the connection tube 12. In this FIG. 7, it is possible to see what has been described above, namely in particular that the overmolding 54 is produced so as to leave a sufficient clearance so that the tabs 20, 24 can flex at the moment of insertion in the connection tube and ensure the contact with the inner surface of the connection tube 12.

The metal bars are oriented in the overmolded block such that the metal tabs 20, 24 of each of the metal bars are disposed against the same wall of the connection tube 12, 14. This configuration makes it possible to house temperature sensors 28, 30 in this connection tube and to ensure that they are in contact with a wall of the tube, namely that wall of the tube opposite the wall with which the metal tabs are in contact. The elasticity of the metal tabs tends to press the overmolding against this opposite wall and the temperature sensors can be disposed on that face of the overmolding 54 which faces this opposite wall. These temperature sensors comprise a connection 50, visible in FIG. 6, which is intended to be connected to the computer bus connection in the electrical connection box 4.

Without departing from the context of the invention, the connection tubes 12, 14 comprising the metal bar 16 could also comprise heating elements.

FIGS. 8 and 9 illustrate another variant of the invention, in which the metal bar 16 and the other metal bar 22 are connected to one another via a rigid metal coupling 17, without an interposed electrical connection member. It will be understood that, in this configuration, the metal tabs 20, 24 of each metal bar participate in the positioning of the metal bars within the connection tube 12, 14, so as to ensure that the tabs and the body are in contact with a wall of the tube, but that they all participate in the grounding of the heating body.

Lastly, in another embodiment variant of the invention (not shown here), the conductive element which protrudes from the tube and is intended to be connected to ground, in accordance with the invention, is formed by an element which is integral with one of the walls of the connection tube 12, 14. The metal bar, as it has been mentioned in the preceding variants, is replaced with a metal finger extending a wall of the connection tube 12, 14, this metal finger therefore forming a longitudinal protrusion of the connection tube 12, 14 at an end of the tube that is placed in a connection zone between the connection box 4 and the heating body 6. It will be understood that, in this case, the tube may incorporate heating elements and/or an electrical connection member, as mentioned above.

The present invention, as it has just been described by means of various embodiments, achieves the aims which it has set itself, namely to propose an electric heating device which provides simplified means for grounding the heating body, which enable rapid mounting of the electric heating device without dimensions of the sealing means needing to be modified.

However, the present invention is not limited to the means and configurations described and illustrated here and it also extends to any equivalent means and configurations and to any technically operational combination of such means.

1. An electric heating device, for a motor vehicle, said electric heating device comprising an electrical connection box and a heating body comprising:
a plurality of heating elements intended to be supplied with current;
a plurality of metal tubes, at least some of which comprise said heating elements; and
a plurality of metal heat sinks,
wherein the metal tubes and the metal heat sinks forming a conductive frame at a same electrical potential,
wherein at least one tube of said plurality of tubes comprises a conductive element which protrudes from said at least one tube and is in electrical contact with said at least one tube,
wherein said protruding element being connected to a ground connector of said electrical connection box,
wherein said element protruding from said at least one tube is a metal bar disposed longitudinally in said at least one tube,
wherein said metal bar comprising at least one metal tab in contact with an inner surface of said at least one tube.

2. (canceled)

3. The electric heating device as claimed in claim 1, wherein said at least one metal tab is a lateral portion of said metal bar, articulated on a body of said metal bar at a base of said metal tab.

4. The electric heating device as claimed in claim 1,
wherein said at least one tube further comprises an electrical connection member protruding from said at least one tube,
wherein a protruding part of said electrical connection member being electrically connected to an electrical power supply in said electrical connection box.

5. The electric heating device as claimed in claim 4, wherein said electrical connection member and said metal bar are at least partially embedded in an insulating polymer material on a longitudinal portion of said electrical connection member and of said metal bar.

6. The electric heating device as claimed in claim 1, wherein said metal bar comprises several metal tabs distributed uniformly along said metal bar.

7. The electric heating device as claimed in claim 1,
wherein said at least one tube further comprises another metal bar comprising one or more metal tabs in contact with said inner surface of said at least one tube,
wherein said metal bar and said other metal bar being disposed on either side of a median plan longitudinally intersecting a width of said at least one tube,
wherein said metal bar and said other metal bar being secured to one another.

8. The electric heating device as claimed in claim 6, wherein said metal tabs of said metal bar or of said metal bar and of another metal bar protrude from a same side of said metal bar or of said metal bars.

9. The electric heating device as claimed in claim 8,
wherein said at least one tube further comprises one or more temperature sensors disposed on an opposite side from said same side of said metal bar or bars,
wherein said temperature sensors being in contact with a wall of said at least one tube.

10. The electric heating device as claimed in claim 1, wherein said at least one tube is disposed at a lateral edge of said heating body.
